(19) United States
(12) Patent Application Publication
(10) Pub. No.: US 2004/0214598 A1
(43) Pub. Date: Oct. 28, 2004

(54) Concealed weapons detection system

(76) Inventor: Ajith Kumar Parameswaran Rajamma, Nagercoil (IN)

Correspondence Address: Daniel K. Nichols, MOTOROLA, INC., 1303 East Algonquin Road, Schaumburg, IL, 60196, US

(21) Appl. No.: 10/421,053

(22) Filed: Apr. 23, 2003

(51) Int. Cl. H04M 1/00

(52) U.S. Cl. 455/556.1; 455/550.1

(57) ABSTRACT

A combination cellular telephone and metal detector provides an unobtrusive and convenient device for law enforcement and security professionals as well as the general public. The metal detector is preferably a resonance type detector and shares the circuitry of the cellular telephone, such as the antenna, digital signal processor, speaker, display and keypad. The device may communicate with a remote computer to compare a signature of a detected object with signatures of known objects stored in a database.

### BACKGROUND OF THE INVENTION

The present invention relates generally to a concealed weapons detection system, and more particularly, to a combination of a personal communication device and a metal detector.

Public safety is one of the most pressing issues facing society today. Security professionals of all types are concerned with the detection of concealed weapons, such as handguns and knives. Accordingly, there are a number of products available for detecting concealed weapons, ranging from large portals through which persons must pass to hand-held metal detectors. For example, U.S. Pat. No. 6,359,582 to MacAleese et al. discloses a radar gun type concealed weapons detection system. However, the radar gun is quite large and is not at all unobtrusive. Garrett Metal Detectors of Garland, Tex. makes a variety of metal detectors, including hand-held wand type sensors and a miniature sensor that can be carried in a hand or pocket. Thus, although handheld or portable weapons detectors are available they are an additional thing for a law enforcement officer to carry and thus burdensome, especially for an officer already outfitted with weapons, ammunition, handcuffs, communications equipment, etc. For the same reasons, it is not convenient for members of the general public to carry a weapons detector.

It is an object of the present invention to provide an unobtrusive hand-held weapons detector that is readily carried.

### BRIEF DESCRIPTION OF THE DRAWINGS

The following detailed description of preferred embodiments of the invention will be better understood when read in conjunction with the appended drawings. For the purpose of illustrating the invention, there is shown in the drawings embodiments that are presently preferred. It should be understood, however, that the invention is not limited to the precise arrangement and instrumentalities shown. In the drawings:

FIG. 1 is a schematic block circuit diagram of a first embodiment of a weapons detection device in accordance with the present invention;

FIG. 2 is a schematic block diagram of a weapons detection device in accordance with the present invention including a remote database; and

FIG. 3 is a block diagram of a second embodiment of a weapons detection device in accordance with the present invention.

### DETAILED DESCRIPTION OF PREFERRED EMBODIMENTS

The detailed description set forth below in connection with the appended drawings is intended as a description of the presently preferred embodiments of the invention, and is not intended to represent the only forms in which the present invention may be practiced. It is to be understood that the same or equivalent functions may be accomplished by different embodiments that are intended to be encompassed within the spirit and scope of the invention. In the drawings, like numerals are used to indicate like elements throughout.

The present invention provides a combination personal communications device, such as a cellular telephone, and a metal detector. Weapons like handguns, rifles, shotguns, pipe bombs and metal objects like long bladed knives can be concealed under clothing and in packages or handbags. Law enforcement and security personnel can use the present invention to detect concealed weapons at ranges of approximately 2-3 meters. The communications device transmits detection signals via an antenna and a digital signal processor (DSP) of the communications device is programmed to include a detection algorithm to process reflected detection signals received by the antenna. The DSP is able to discriminate and identify the signature of a weapon, including a firearm or a large knife blade.

Accordingly, in one embodiment, the present invention is a concealed weapons detection device, comprising an antenna, a RF transceiver, a digital circuit section, and a user interface means. The antenna receives and transmits RF communications signals in a first predetermined frequency range, transmits weapons detection signals in a second predetermined frequency range, and receives reflected ones of the weapons detection signals. The RF transceiver is coupled to the antenna for filtering and converting the received and transmitted signals. The digital circuit section is coupled to the RF transceiver for providing communications signals to the RF transceiver for RF transmission via the antenna, receiving and processing communications signals from the RF transceiver that have been received via the antenna, for providing weapons detection signals to the RF transmitter for transmission via the antenna, and receiving and processing reflected weapons detection signals from the RF transceiver that have been received via the antenna. The user interface means is connected to the digital circuit section for allowing a user to interface therewith, wherein in a first mode the weapons detection device functions as a personal communications device and in a second mode the weapons detection device functions as a weapons detector.

In another embodiment, the present invention is an improved cellular communication device including an antenna for transmitting and receiving RF communication signals, communications electronic circuitry including a digital signal processor (DSP) coupled to the antenna for processing the RF communications signals, and user interface means for allowing a user to input instructions and data and receive data, wherein the improvement comprises means for generating weapons detection signals for transmission via the antenna, and wherein the antenna receives reflected ones of the weapons detection signals, and the DSP is programmed to analyze the received reflected weapons detection signals to determine whether a weapon is proximate to the device.

In yet another embodiment, the present invention is a method of detecting a concealed weapon, comprising the steps of:

combining circuitry for a resonance type metal detector with circuitry for a personal communication device, wherein the combined circuitry includes an antenna and a digital signal processor (DSP);

in response to a predetermined command, transmitting electromagnetic waves via the antenna and receiving waves reflected by a metal object;

analyzing the received reflected waves with the DSP to determine the presence of a proximate metal object that reflected said waves; and

the DSP generating a signal indicating whether a weapon has been detected.

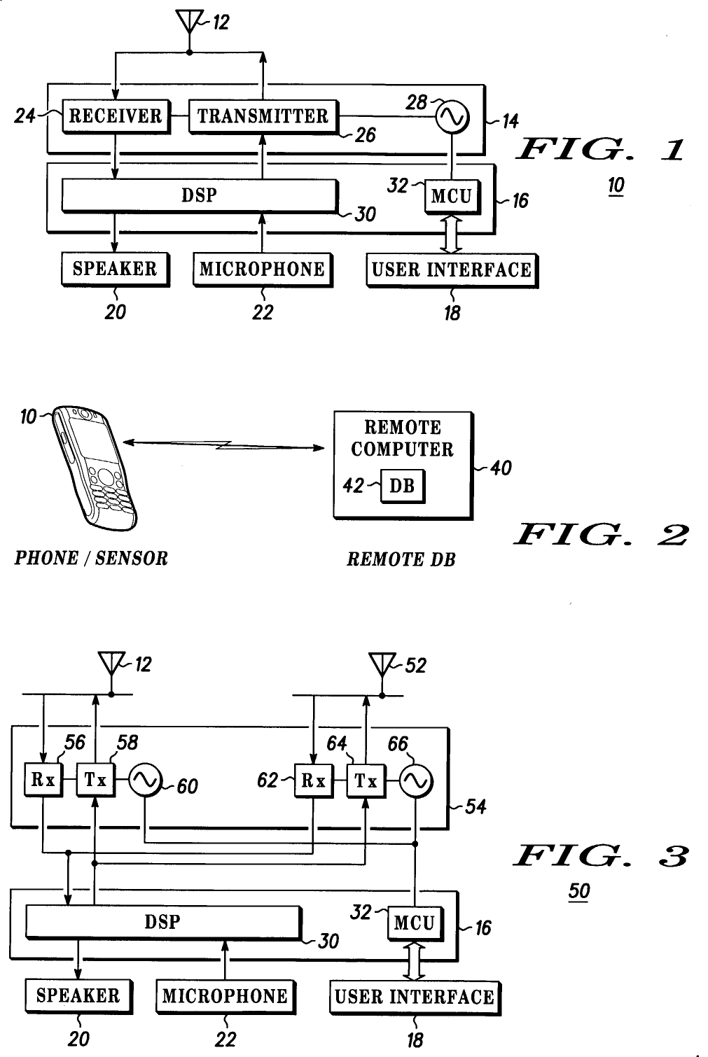

Referring now to FIG. 1, a schematic block diagram of a concealed weapons detection device 10 is shown. The detection device 10 can function as both a weapons detector and a personal communication device, such as a two-way radio or a cellular telephone. Thus, in a first mode, the detection device 10 functions as a personal communications device and in a second mode the weapons detection device functions as a weapons detector. In the presently preferred embodiment, the weapons detector is a metal detector, which is described in more detail below. However, it will be understood by those of skill in the art that other types of weapons detectors may be substituted for a metal detector. Further, as two-way radios and cellular telephones are understood by those of skill in the art, a detailed description of these functions is not required for a complete understanding of the present invention.

A metal detector is a device designed to detect metal objects carried by people or within bags, boxes or suitcases, or otherwise hidden from view. Metal detectors are commonly found in airports, prisons, government buildings, offices and even schools, and help ensure that no one is bringing a weapon onto the premises. Consumer-oriented metal detectors are available and typically used by people to discover hidden treasures. A typical metal detector includes one or more antennas, analog circuitry, controls, a user interface, a power source and a microprocessor. Operating a metal detector is simple. Once turned on, it is moved slowly over an area of interest. When the antenna passes over a target object, an audible alarm is sounded. A display that pinpoints the type of metal detected and its distance from the detector may also be provided.

Metal detectors typically use one of three technologies, very low frequency (VLF), resonance or pulse induction (PI), or beat-frequency oscillation (BFO). VLF, also known as induction balance, is the most common detector technology. A VLF metal detector uses two coils, a transmitter or outer coil and a receiver or inner coil. A current is provided in the transmitter coil, first in one direction and then in the opposite direction. The number of times that the current switches direction per second is its frequency. The receiver coil acts as an antenna to pick up and amplify frequencies from target objects. The current in the transmitter coil creates an electromagnetic field with a polarity that is perpendicular to the coil. Each time the current changes direction, the polarity of the magnetic field changes. As the magnetic field pulses, it interacts with any conductive objects it encounters, causing the objects to generate their own magnetic fields, which are opposite the transmitter coil's magnetic field. The receiver coil detects the magnetic field generated by the object and a current is generated in the receiver coil that oscillates at the same frequency as the object's magnetic field. The detected frequency is amplified and provided to the controller, where it is analyzed. The controller analyzes the amplified signal to determine approximately how far the object is from the coil based on the strength of the magnetic field generated by the object. The closer the object, the stronger the magnetic field. Phase shifting caused by the inductance or resistance of the detected object is used to distinguish between different metals.

A resonance type metal detector can use a single coil as both transmitter and receiver. Alternatively, two or more three coils working together could be used. A resonance system sends powerful, short bursts (pulses) of current through the coil. Each pulse generates a brief magnetic field. When the pulse ends, the magnetic field reverses polarity and collapses, causing a sharp electrical spike. This spike causes a short reflected pulse to run through the coil before another pulse or burst is sent through the coil. A typical resonance type metal detector sends about 100 pulses per second, but the number can vary, ranging from about 50 pulses per second to over a thousand. If the coil is near a metal object, the pulse creates an opposite magnetic field in the metal object. When the pulse's magnetic field collapses, causing the reflected pulse, the magnetic field of the object extends the length of the reflected pulse. A sampling circuit monitors the length of the reflected pulse and compares the reflected pulse length to an expected value to determine if another magnetic field has caused the reflected pulse to take longer to decay. If the decay of the reflected pulse is longer than a predetermined value, it is determined that a metal object has been detected. The sampling circuit sends the reflected pulse signal to an integrator, which amplifies and converts it to direct current (DC). A DC voltage is then used to indicate the detection of a metal object. For instance, if a predetermined DC voltage is obtained, a signal is provided to the display circuit, audio circuit, or both, which indicates that a metal object has been detected.

A third way to detect metal uses a technology called beat-frequency oscillator (BFO). In a BFO system, there are two spaced coils of wire, a transmit coil and a smaller, receiver coil. Each coil is connected to an oscillator that generates thousands of pulses of current per second. The frequency of these pulses is slightly offset between the two coils. As the pulses travel through each coil, the coil generates radio waves. A tiny receiver within the controller receives the radio waves and creates an audible series of tones (beats) based on the difference between the frequencies. If the transmit coil passes over a metal object, the magnetic field caused by the current flowing through the coil creates a magnetic field around the object that interferes with the frequency of the radio waves generated by the transmit coil. As the frequency deviates from the frequency of the receiver coil, the audible beats change in duration and tone. Although BFO-based systems are low-cost and easy to manufacture, they are not as accurate as VLF or resonance systems. As discussed in more detail below, a preferred embodiment of the present invention uses the resonance type system. However, as will be understood by those of skill in the art, other metal detection systems can be combined with existing cell phone circuitry with little additional circuitry or software required to provide a dual purpose device, and thus are within the scope of the invention.

Referring again to FIG. 1, the detection device 10 includes an antenna 12 for receiving and transmitting RF communications signals in a first predetermined frequency range as required for performing communications such as cellular telephone communications. The antenna 12 is also used to transmit weapons detection signals in a second predetermined frequency range and receive reflected ones of the weapons detection signals. That is, as is understood by those of skill in the art and described in more detail below, when a transmitted weapons detection signal comes in contact with a metal object, a part of the signal is reflected back towards the antenna. The antenna 12 receives such reflected signals.

The antenna 12 is coupled to a RF transceiver 14, which filters and converts the received and transmitted signals. The RF transceiver 14 is coupled to a digital circuit section 16 that provides communications signals to the RF transceiver 14 for RF transmission via the antenna 12. The digital circuit section 16 also receives and processes communications signals from the RF transceiver 14 that have been received via the antenna 12. The digital circuit section 16 further provides weapons detection signals to the RF transceiver 14 for transmission via the antenna 12, and receives and processes any reflected weapons detection signals provided from the RF transceiver 14 that have been received via the antenna 12.

A user interface means 18 is connected to the digital circuit section 16 for allowing a user to interface therewith. The user interface means 18 preferably comprises a keypad having a plurality of buttons as typically found on a hand-held communication device that allow instructions or commands to be entered into the device 10. Alternatively, the device 10 may be operated via a touch pad type interface having virtual keys. The user interface means 18 also comprises a display screen such as an LCD or a color LCD. The device 10 may also accept voice or audio commands. The device 10 includes a speaker 20 and a microphone 22 to facilitate communications operations.

The RF transceiver 14 further includes an RF receiver coupled to the antenna 12 for converting RF communications signals and reflected weapons detection signals received by the antenna 12 to digital signals and providing the digital signals to the digital circuit section 16. As is known by those of skill in the art, the receiver 24 provides signal filtering and down converting. A transmitter 26 is also coupled to the antenna 12 for converting the communications signals received from the digital circuit section 16 to RF signals in the first predetermined frequency range. The transmitter 26 also converts the weapons detection signals received from the digital circuit section 16 to the weapons detection signals in the second predetermined frequency range. A synthesizer 28 is connected to the transmitter 26 and the receiver 24 for assisting in converting the communications signals and the weapons detections signals to and from the first and second predetermined frequency ranges.

The presently preferred embodiment uses a resonance weapon detection system. When an object of length L is illuminated with electromagnetic waves of wavelength λ the resonance region typically is defined as 1<L/λ<10 and the resonance peak occurs at about L=n×λ/2 where n=1,2,3 . . . . Present ranges of mobile phone frequencies from 800 MHz to 2,000 MHz can be used to detect a wide range of metal weapons of lengths from about 15 cm to 3 m. These frequencies easily penetrate cardboard, clothing materials such as cotton and leather, some plastics, bricks and doors. Thus, the predetermined first and second frequency ranges are both preferably within the 800 MHz to 2000 MHz or higher range. When the electromagnetic resonance occurs some part of the energy is reradiated with a different polarization than that of the transmitted waves. The ratio of the like-polarization to the cross-polarization scattered from the metal object is used as a signature to identify the type and presence of a metal object or weapon. Another signature is the presence of high frequencies in the detected signal due to higher order resonance peaks from the metal target.

The digital circuit section 16 includes a digital signal processor (DSP) 30 for receiving and analyzing the digital signals received from the receiver 24 and for generating the communications signals and weapons detection signals provided to the transmitter 26. The DSP 30 is used to determine the presence of a weapon based on the signature determined from the received reflected waves. The DSP 30 generates a signal indicating the presence or absence of a weapon. The signal may be used to generate a visible and/or audible warning mechanism to inform the user of the presence or absence of a weapon. In one embodiment of the invention, the DSP 30 compares the digital signature of the received reflected waves with pre-stored weapons signatures, stored in an internal memory (not shown) to determine the presence of a weapon and also a type of weapon detected.

Referring now to FIG. 2, a diagram of a second embodiment of the invention is shown in which the detection device 10 transmits a signature generated from received reflected waves via the RF transceiver 14 to a remote processor 40 having a database 42 of prestored weapons signatures. The remote processor 40 receives the weapons signature from the device 10 and compares the received signature with the pre-stored signatures in the database 42. If there is a match, the remote processor 40 sends a signal back to the device 10 indicating the type of weapon that has been detected by the device 10. If there is no match, the remote processor 40 can provide further processing to determine whether the signature is indicative of a weapon or some other object, and transmit a message back to the device 10 providing any such further information on the detected object. While messages may be transmitted in a number of ways, in a preferred embodiment, the detection device 10 transmits the signature as a message using the SMS protocol. As is known by those of skill in the art, most cellular telephones are equipped to send and receive SMS messages. Alternatively, the remote processor 40 could return an MMS message including a picture of the type of weapon indicated by the signature.

Referring again to FIG. 1, as previously discussed, the DSP 30 is connected to a speaker 20 and a microphone 22. The speaker 20 and microphone 22 are used in the weapons detection mode to indicate the presence or absence of a weapon. In the communications mode, the speaker 20 and microphone 22 allow a user to input and receive voice data. As is known by those of skill in the art, such voice data is converted to communications signals.

The digital circuit section 16 further comprises a microcontroller (MCU) 32 connected to the synthesizer 28 for controlling the operation of the synthesizer 28. The MCU 32 is also connected to the user interface 18 for allowing a user to issue instructions thereto. For example, a user may instruct the device to operate in one of the first and second modes by way of the user interface 18. Preferably the detection device 10 has a menu option or icon to activate the weapons detection mode. Alternatively, a separate key may be provided on the keypad to allow the device 10 to function as a metal detector. Once the feature is selected using the menu or by pressing the key, the device 10 will transmit the required frequencies with required power for the weapon/metal detection for a short duration.

Referring now to FIG. 3, an alternative embodiment of a detection device 50 is shown that includes a directional antenna 52 coupled to an RF transceiver 54 for transmitting the weapons detection signals in the second predetermined frequency range and receiving the reflected ones of the weapons detection signals. In this embodiment, the first antenna 12 is used only for transmitting and receiving communications signals. Thus, the first antenna 12 is connected to a communications receiver circuit 56 and a communications transmitter circuit 58, which are connected to a first oscillator 60. The directional antenna 52 is connected to a detector receiver circuit 62 and a detector transmitter circuit 64, which are connected to a second oscillator 66. The receiver circuits 56 and 62 and the transmitter circuits 58 and 64 are connected to the DSP 30, which processes the received and transmitted signals. The first and second oscillators 60 and 66 are connected to the MCU 22, which controls operations of the oscillators 60 and 66. The other circuitry is essentially the same as in the first embodiment. A directional antenna achieves more power in one direction for transmission and reception and boosts the ranges of detection of weapon. With a directional antenna and with the mobile phones transmission power of +23 dB (200 mW) a detection range of about 2-3 meters can be achieved. With omni direction antennas of the mobile devices the range of detection of metal/weapon is about 0.5 meters or less.

Although, as discussed above, the first antenna 12 is used for communications and the second antenna 52 is used for metal detection, the two antennas 12 and 52 could be used together for metal detection, as described above with reference to VLF and BFO type metal detectors.

The present invention also provides a method of detecting a concealed weapon by combining circuitry for a resonance type metal detector with circuitry for a personal communication device, as discussed above, where the combined circuitry includes an antenna and a digital signal processor (DSP). Then, in response to a predetermined command, the device transmits electromagnetic waves via the antenna and receives waves reflected by a metal object. The received waves are analyzed by the DSP to determine the presence of a proximate metal object that reflected the waves. The DSP then generates a signal indicating whether a weapon has been detected. For example, the presence of a metal object is indicated by an audio warning tone and a red light or message in red text on the display screen. Other possible indicators that are already available with a mobile phone can be used, like ring tones, silent vibrations, and other visual signals like LED indicators. The present invention can be used for detecting weapons, detonators or other small pieces of metal on people or in parcels, baggage, correspondence, fabric and so on. Thus, the present invention extends a mobile device's capability to detect weapons or metal objects like handguns, rifles, shotguns, pipe bombs or knives. The metal objects or weapons can be detected in or under clothing or other objects such as briefcases, purses, and paper/cloth bags. Since mobile phones are ubiquitous, searches may be carried out surreptitiously. Further, adding weapon/metal detection capability to mobile devices like mobile phones, PDAs or two-way radios is very useful for law enforcement agency personal, the military and private security personal and for police. In general they don't carry a weapon detector with them because it is an extra bulky and costly item to carry. However, since most of these personnel use mobile devices, there is a great potential for even a low range weapon detector mobile device to become an essential item among them. These mobile devices will be useful among personnel in financial institutions, convenience stores and other retail businesses, airports, schools and owners of private office and apartment buildings.

The description of the preferred embodiment of the present invention has been presented for purposes of illustration and description, but is not intended to be exhaustive or to limit the invention to the form disclosed. Thus, changes could be made to the embodiment described above without departing from the inventive concept thereof. It is understood, therefore, that this invention is not limited to the particular embodiment disclosed, but covers modifications within the spirit and scope of the present invention as defined by the appended claims.

1. A concealed weapons detection device, comprising:
an antenna for receiving and transmitting RF communications signals in a first predetermined frequency range, transmitting weapons detection signals in a second predetermined frequency range, and receiving reflected ones of the weapons detection signals;
a RF transceiver coupled to the antenna for filtering and converting the received and transmitted signals;
a digital circuit section coupled to the RF transceiver for providing communications signals to the RF transceiver for RF transmission via the antenna, receiving and processing communications signals from the RF transceiver that have been received via the antenna, for providing weapons detection signals to the RF transceiver for transmission via the antenna, and receiving and processing reflected weapons detection signals from the RF transceiver that have been received via the antenna; and
user interface means connected to the digital circuit section for allowing a user to interface therewith, wherein in a first mode the weapons detection device functions as a personal communications device and in a second mode the weapons detection device functions as a weapons detector.

2. The concealed weapons detection device of claim 1, wherein in the first mode the weapons detection device functions as a cellular telephone.

3. The concealed weapons detection device of claim 1, wherein in the first mode the weapons detection device functions as a two-way radio.

4. The concealed weapons detection device of claim 1, wherein in the second mode the weapons detection device functions as a metal detector.

5. The concealed weapons detection device of claim 4, wherein in the second mode the weapons detection device transmits via the antenna electromagnetic pulses over a range of frequencies within the second predetermined frequency range and receives reflected ones of the electromagnetic pulses.

6. The concealed weapons detection device of claim 1, wherein the RF transceiver further comprises:
an RF receiver coupled to the antenna for converting the RF communications signals and the reflected weapons detection signals received by the antenna to digital signals and providing said digital signals to the digital circuit section;
a transmitter coupled to the antenna for converting the communications signals received from the digital circuit section to RF signals in the first predetermined frequency range, and for converting the weapons detection signals received from the digital circuit section to the weapons detection signals in the second predetermined frequency range; and
a synthesizer connected to the transmitter and the receiver for assisting in converting the communications signals and the weapons detections signals to the first and second predetermined frequency ranges.

7. The concealed weapons detection device of claim 6, wherein the digital circuit section further comprises:
a digital signal processor for receiving and analyzing the digital signals received from the receiver and for generating the communications signals and weapons detection signals provided to the transmitter.

8. The concealed weapons detection device of claim 7, wherein the digital signal processor is connected to a speaker and a microphone for allowing a user to input and receive voice data, wherein the voice data is converted to the communications signals.

9. The concealed weapons detection device of claim 8, wherein the digital signal processor analyzes a digital signature of the received reflected waves to determine the presence of a weapon.

10. The concealed weapons detection device of claim 9, wherein the digital signal processor compares the digital signature of the received reflected waves with pre-stored weapons signatures to determine a type of weapon detected.

11. The concealed weapons detection device of claim 9, wherein the digital signal processor provides the digital signature of the received reflected waves to the RF transceiver for transmission to a remote processor having a database.

12. The concealed weapons detection device of claim 11, wherein the digital signature is transmitted to the remote processor as an SMS message.

13. The concealed weapons detection device of claim 9, wherein the digital circuit section further comprises:
a microcontroller connected to the synthesizer for controlling the operation of the synthesizer.

14. The concealed weapons detection device of claim 13, wherein the user interface is connected to the microcontroller for allowing a user to issue instructions thereto.

15. The concealed weapons detection device of claim 1, wherein a user instructs the device to operate in one of the first and second modes by way of the user interface.

16. The concealed weapons detection device of claim 1, further comprising a directional antenna coupled to the RF transceiver for transmitting the weapons detection signals in the second predetermined frequency range and received the reflected ones of the weapons detection signals.

17. A concealed weapons detection device, comprising:
an electrical power source;
a first circuit, capable of generating an RF communications signal in a first predetermined frequency range, connected to the electrical power source;
a second circuit, capable of generating a high frequency signal in a second predetermined frequency range, operably connected to the electrical power source;
an antenna connected to the first and second circuits for transmitting the RF communications signal and the high frequency signal, and receiving reflections of the high frequency signal caused by the high frequency signal contacting metal objects proximate to the antenna; and
a digital signal processor, connected to the antenna by way of the second circuit, for analyzing the received reflected signal and generating a data signal indicating the presence of a metal object.

18. An improved cellular communication device, the cellular communication device including an antenna for transmitting and receiving RF communication signals, communications electronic circuitry including a digital signal processor (DSP) coupled to the antenna for processing the RF communications signals, and user interface means for allowing a user to input instructions and data and receive data, wherein the improvement comprises:
means for generating weapons detection signals for transmission via the antenna, and wherein the antenna receives reflected ones of the weapons detection signals; and
the DSP being programmed to analyze the received reflected weapons detection signals to determine whether a weapon is proximate to the device.

19. An improved cellular communication device, the cellular communication device including an antenna for transmitting and receiving RF communication signals, communications electronic circuitry including a digital signal processor (DSP) coupled to the antenna for processing the RF communications signals, and user interface means for allowing a user to input instructions and data and receive data, wherein the improvement comprises:
means for generating radar signals for transmission via the antenna, and wherein the antenna receives reflected ones of the radar signals; and
wherein the DSP is programmed to analyze the received reflected radar signals.

20. A method of detecting a concealed weapon, comprising the steps of:
combining circuitry for a resonance type metal detector with circuitry for a personal communication device, wherein the combined circuitry includes an antenna and a digital signal processor (DSP);
in response to a predetermined command, transmitting electromagnetic waves via the antenna and receiving waves reflected by a metal object;
analyzing the received reflected waves with the DSP to determine the presence of a proximate metal object that reflected said waves; and
the DSP generating a signal indicating whether a weapon has been detected.
